(19) United States
(12) Patent Application Publication
(10) Pub. No.: US 2021/0054681 A1
(43) Pub. Date: Feb. 25, 2021

(54) Method for Producing a Glass Sheet for Vacuum Insulating Glass

(71) Applicant: arcon Flachglas-Veredlung GmbH & Co. KG, Feuchtwangen (DE)

(72) Inventors: Hermann Dehner, Neuendettelsau (DE); Franz Schaumberger, Aschach/Steyr (AT)

(21) Appl. No.: 16/963,165

(22) PCT Filed: Jan. 25, 2019
(86) PCT No.: PCT/EP2019/051882

§ 371 Date: Jul. 17, 2020

(30) Foreign Application Priority Data
Feb. 1, 2018 (DE) 10 2018 102 233.6

(51) Int. Cl. E06B 3/66; E06B 3/663

(52) U.S. Cl. CPC E06B 3/6612; E06B 3/6775; E06B 3/66304

(57) ABSTRACT

A method for producing a glass sheet is disclosed. In an embodiment a method includes applying a plurality of supporting bodies to the glass sheet, wherein applying the supporting bodies to the glass sheet includes performing a float glass process while producing the glass sheet, and wherein the supporting bodies are applied while the glass sheet has a temperature above a glass transition temperature so that the supporting bodies partially fuse with the glass sheet.

This patent application is a national phase filing under section 371 of PCT/EP2019/051882, filed Jan. 25, 2019, which claims the priority of German patent application 102018102233.6, filed Feb. 1, 2018, each of which is incorporated herein by reference in its entirety.

### TECHNICAL FIELD

The present application concerns a method for producing a glass sheet. The glass sheet, for example a float glass sheet, is intended in particular as a semi-finished product for further processing into vacuum insulating glass.

### BACKGROUND

Vacuum insulating glass (VIG) is particularly used as thermal insulation glazing, especially for architectural glazing. Conventional thermal insulation glazing usually has an insulating glass consisting of two or three glass sheets, whereby the at least one space between the sheets can be filled with a noble gas such as argon. Vacuum insulating glass differs from such conventional thermal insulation glazing in that the space between the sheets is evacuated, i.e., there is no filling with a noble gas. In the case of vacuum insulating glass, the sheet compound is sealed gas-tight at the edge, e.g. soldered or welded. This ensures that the vacuum in the space between the sheets is maintained over the service life of the thermal insulation glazing.

Compared to conventional thermal insulation glazing, vacuum insulating glass has the advantage that the thermal insulation is considerably higher than if the space between the sheets is filled with a noble gas due to the lack of a medium in the space between the sheets. However, a disadvantage of evacuating the space between the sheets is that the external atmospheric pressure puts a considerable pressure on the glass sheets. This makes it necessary to insert supporting bodies between the glass sheets, which are usually arranged in a regular grid between the sheets. Particularly in the case of large-area sheets, the application of the supporting bodies, for example by gluing them to one of the glass sheets before joining the two glass sheets, can be laborious and cost-intensive.

### SUMMARY

Embodiments provide a method of the production of a glass sheet, which is intended as a semi-finished product for further processing into vacuum insulating glass, in which the supporting bodies for the space between the sheets are applied in a particularly efficient manner.

According to at least one embodiment of the method of producing the glass sheet, a plurality of supporting bodies is applied to the glass sheet. In the finished vacuum insulating glass, the supporting bodies serve as spacers between the glass sheet and a second glass sheet in order to maintain a predetermined space between the glass sheets, in particular despite the external atmospheric pressure.

In the method described here, the supporting bodies are advantageously applied during the production of the glass sheet in a float glass process. A float glass process is a process known per se for the production of flat glass in which a liquid glass melt is passed onto a bath of liquid tin. The glass floats on this bath of liquid tin and spreads evenly, whereby the surface tension of the tin and the liquid glass results in glass sheets with very smooth surfaces. The glass is typically drawn out continuously at the cooler end of the tin bath and then typically passes through a lehr where it is cooled down. In the method described herein, the support bodies are advantageously applied to the glass sheet before the glass sheet is cooled below the glass transition temperature Tg, so that the support bodies partially fuse with the glass sheet.

The application of the supporting bodies is thus advantageously integrated into the float glass method. Because the supporting bodies are applied to a region of the glass sheet which has a temperature above the glass transition temperature Tg and partially fuse with the glass sheet, it is in particular not necessary to attach the supporting bodies to the glass sheet in any other way, for example by gluing. The effort required to apply a suitable connecting means for fixing the supporting bodies, e.g. an adhesive, is therefore unnecessary. This is particularly advantageous in the case of large-area glass sheets, which are used in particular as thermal insulation glazing and/or solar protection glazing. In particular, it is possible that the support bodies are dropped from a suitable feeding device onto the glass sheet before the glass sheet has cooled down below the glass transition temperature.

According to a configuration, the support bodies are applied to an area of the glass sheet which has a temperature of at least 600° C. At such a high temperature, the glass sheet is in particular still in a viscous state so that the supporting bodies, which are preferably also made of glass, partially fuse with the glass sheet.

According to at least one embodiment, the supporting bodies are applied to the glass sheet before the glass sheet is fed into a lehr. The glass sheet is produced in particular by a float glass process in which the glass is passed in the molten state onto a bath of liquid tin to produce the glass sheet and the glass sheet is then fed into a lehr. This process is known per se from the conventional production of flat glass. The method described herein makes use of the idea of integrating the application of support bodies for the vacuum insulating glass into the float glass process, whereby the support bodies are applied to the glass sheet at a point in time when the temperature in the area to which the support bodies are applied has not yet fallen below the glass transition temperature. This can be done in particular immediately after leaving the bath of liquid tin in the transition region to the lehr.

According to an advantageous embodiment, the supporting bodies consist of a glass. In this case, the supporting bodies are advantageously transparent and are not very noticeable in the finished insulating glass.

According to an advantageous embodiment, the supporting bodies are glass spheres. In principle, it is conceivable that the shape of the supporting bodies deviates from a spherical shape, although a spherical shape is advantageous if the supporting bodies are dropped from a suitable feeding device onto the not yet solidified glass sheet. Due to the spherical symmetry, it is advantageously irrespective for glass spheres in which orientation they strike the glass sheet.

Preferably, the supporting bodies, especially glass spheres, have diameters in the range of 0.1 mm to 1 mm before being applied to the glass sheet. The desired distance between the glass sheet and a second glass sheet can be achieved by selecting the appropriate diameter of the supporting bodies.

According to an advantageous configuration, the glass sheet is moved in a transport direction when the supporting bodies are applied. The application of the supporting bodies can be carried out in particular while the glass sheet is continuously drawn on the bath of liquid tin. The transport speed in the transport direction is preferably between 1 m/min and 20 m/min.

According to at least one embodiment, the supporting bodies are dropped onto the glass sheet from a feeding device which is not moved in the transport direction. In this case, a distance d at which the supporting bodies are applied to the glass sheet in the transport direction results from the quotient of the transport speed and the time interval at which the supporting bodies are dropped onto the glass sheet. Preferably, the supporting bodies are dropped onto the glass sheet at a fixed frequency in order to apply the supporting bodies to the glass sheet at a predetermined distance d. Preferably the distance d in the transport direction is between 10 mm and 50 mm.

In a preferred configuration, the feeding device for the supporting bodies has several outlet openings in a direction perpendicular to the transport direction of the glass sheet in order to drop several supporting bodies onto the glass sheet simultaneously. Preferably, the multiple outlet openings have a fixed distance b, so that the supporting bodies are applied to the glass sheet at a fixed distance b in the direction transverse to the transport direction. Preferably, the distance b perpendicular to the direction of transport is between 10 mm and 50 mm.

As an alternative to a feeding device with several outlet openings in the direction perpendicular to the transport direction, it is also possible to arrange several feeding devices for the supporting bodies next to each other in the direction perpendicular to the transport direction. In this case, the distance between the outlet openings of the respective feeding devices corresponds to the distance b in which the supporting bodies are applied to the glass sheet in the direction perpendicular to the transport direction.

In a preferred configuration, the distance d at which the supporting bodies are applied to the glass sheet in the direction parallel to the direction of transport and the distance b at which the supporting bodies are applied to the glass sheet in the direction perpendicular to the direction of transport are substantially equal.

The glass sheet which can be produced by the method is further processed, in particular into vacuum insulating glass.

According to a configuration of the method, the glass sheet is connected in particular to a second glass sheet, whereby a space between the glass sheet and the second glass sheet is evacuated. The supporting bodies act advantageously as spacers between the glass sheet and the second glass sheet.

### BRIEF DESCRIPTION OF THE DRAWINGS

The invention is explained in more detail below on the basis of exemplary embodiments in connection with FIGS. 1 to 4.

In the Figures:

FIG. 1 shows a schematic representation of the application of the support bodies to the glass sheet in an example of the method;

FIG. 2 shows a schematic representation of the application of the support bodies to the glass sheet in an example of the method in a section perpendicular to the direction of transport;

FIG. 3 shows a top view of an example of the glass sheet after the support bodies have been applied; and

FIG. 4 shows a schematic representation of a cross-section through an example of a vacuum insulating glass that can be produced with the method.

### DETAILED DESCRIPTION OF ILLUSTRATIVE EMBODIMENTS

Similar or similarly acting elements are marked with the same reference signs in the figures. The sizes and proportions of the elements shown are not to be regarded as true to scale.

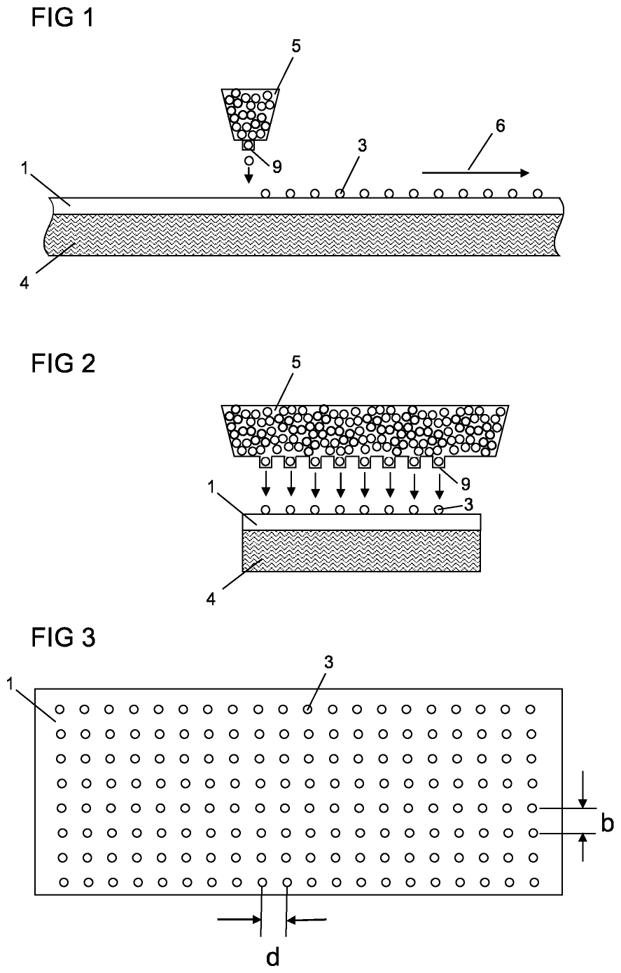

FIG. 1 shows schematically a step in the method in which the supporting bodies 3 are applied to the glass sheet 1. The glass sheet 1 is produced in particular by a float glass process. For example, glass sheet 1 is produced in a continuous float glass process in which glass is continuously fed from a melt at one end of a bath of hot tin 4 and the glass sheet produced on the bath of hot tin 4 is continuously withdrawn from the bath in the transport direction 6 and fed into a lehr. The glass sheet is moved in a transport direction 6 by a suitable transport device. The support bodies 3 can be applied in particular before the glass sheet 1 is transported into the lehr for cooling. During the application of the support bodies 3, the glass sheet 1 is preferably still in front of the lehr, especially on or immediately after the hot tin bath 4.

The supporting bodies 3 are preferably made of a glass. Supporting bodies 3 are in particular glass spheres which preferably have a diameter between 0.1 mm and 1 mm. Supporting bodies 3, which consist of a glass, have the advantage that they are transparent. Furthermore, the supporting bodies 3 are not eye-catching in vacuum insulating glass with diameters of only 0.1 mm to 1 mm.

In the illustrated exemplary embodiment of the method, the supporting bodies 3 are dropped from a feeding device 5 onto the glass sheet 1 before the glass sheet 1 is fed into the annealing furnace. During the application of the support bodies 3, the glass sheet 1 still has a temperature above the glass transition temperature Tg of the glass used. The glass transition temperature Tg can be about 550° C., for example. Preferably, the glass sheet has a temperature of more than 600° C. when the supporting bodies are applied. At such a high temperature the glass sheet 1 is still viscous, so that the applied supporting bodies 3 partially fuse with the glass sheet 1 and are thus attached to the glass sheet 1. In particular, the supporting bodies 3 are firmly attached to the glass sheet 1 after the glass sheet 1 has cooled down.

The feeding device 5 has at least one outlet opening 9 from which the supporting bodies 3 are dropped onto the glass sheet 1, preferably at a fixed frequency. In this way it is achieved that the supporting bodies 3 are applied to the glass sheet 1 in the transport direction 6 at a predetermined grid spacing which is equal to the quotient of the transport speed and the time interval at which the supporting bodies 3 are dropped onto the glass sheet 1.

FIG. 2 is a purely schematic section in the direction perpendicular to the transport direction 6. The transport direction 6 is therefore perpendicular to the drawing plane. In order to apply the supporting bodies 3 to the glass sheet 1 in a two-dimensional grid arrangement, the feeding device 5 can have a large number of outlet openings 9 in the direction perpendicular to the transport direction 6, which are arranged at a predetermined distance. In this way, the supporting bodies 3 can be applied simultaneously in a row perpendicular to the transport direction over the entire width of the sheet. Alternatively, it would also be possible to arrange a large number of separate feeding devices 5 next to each other in the direction perpendicular to the transport direction at a predetermined grid spacing.

FIG. 3 schematically shows a top view of the glass sheet 1 that can be produced using the method described here. The glass sheet has a grid arrangement of supporting bodies 3. After production using the method described here, the supporting bodies 3 are firmly attached to the glass sheet 1, as they partially melt into the glass sheet 1. The supporting bodies 3 are arranged in the longitudinal direction of the glass sheet 1, which may correspond in particular to the transport direction in the float glass process, preferably at a fixed grid spacing d, where d is in the range from 10 mm to 50 mm, for example. In the transverse direction of the glass sheet 1, the supporting bodies 3 are advantageously arranged at a fixed grid spacing b, which may in particular be equal to the spacing of the outlet openings 9 of the feed device 5 for the supporting bodies 3. Preferably, the grid spacing b in the transverse direction of the glass sheet 1 is in the range of 10 mm to 50 mm. The grid spacings in the longitudinal and transverse directions are preferably essentially the same, i.e., d=b.

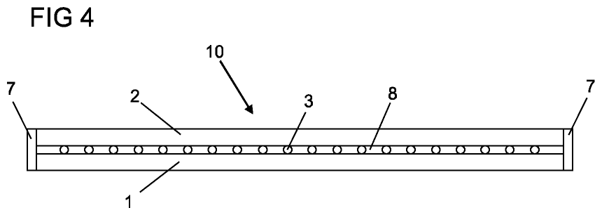

FIG. 4 schematically shows a cross-section of a vacuum insulating glass 10 which can be produced using the method described here. To complete the vacuum insulating glass 10, the glass sheet 1, to which the supporting bodies 3 were applied using the method described, was joined to a second glass sheet 2.

It is possible that at least one of the glass sheets 1, 2 is provided with a coating, in particular a heat-reflecting coating.

The glass sheets 1, 2 have been provided with an edge seal 7, which seals the space 8 between the sheets gas-tight. The edge seal 7 may in particular consist of a metal, a metal alloy, a solder glass or an organic sealant. The space between the sheets 8 is evacuated by the vacuum insulating glass. For this purpose, a valve (not shown) may be provided in the area of edge seal 7, for example. The use of supporting bodies 3 made of glass, in particular glass spheres, has the advantage that the supporting bodies 3 in the finished vacuum insulating glass 10 are less noticeable due to their transparency than when using supporting elements made of non-transparent materials such as metals. Furthermore, the vacuum insulating glass 10 can be produced in a particularly cost-efficient manner, since the supporting bodies 3 are attached to the glass sheet 1 by partial fusion when applied to the still viscous glass of the glass sheet 1, without the need to apply a connecting means such as an adhesive layer in a separate method step. The method is particularly advantageous for the production of large-area sheets such as solar protection or thermal insulation glazing in the architectural sector.

The invention is not limited by the description based on the exemplary embodiments. Rather, the invention comprises each new feature as well as each combination of features, which in particular includes each combination of features in the claims, even if this feature or combination itself is not explicitly stated in the claims or exemplary embodiments.

1-13. (canceled)

14. A method of producing a glass sheet, the method comprising:
applying a plurality of supporting bodies to the glass sheet,
wherein applying the supporting bodies to the glass sheet comprises performing a float glass process while producing the glass sheet, and
wherein the supporting bodies are applied while the glass sheet has a temperature above a glass transition temperature so that the supporting bodies partially fuse with the glass sheet.

15. The method according to claim 14, wherein the glass sheet has a temperature of at least 600° C. when applying the supporting bodies.

16. The method according to claim 14, wherein the supporting bodies are applied to the glass sheet before the glass sheet is fed into a lehr.

17. The method according to claim 14, wherein the supporting bodies consist essentially of a glass.

18. The method according to claim 14, wherein the supporting bodies are glass spheres.

19. The method according to claim 14, wherein the supporting bodies have diameters in a range from 0.1 mm to 1 mm.

20. The method according to claim 14, wherein the supporting bodies have spacings in a range from 10 mm to 50 mm.

21. The method according to claim 14, wherein the glass sheet is moved in a transport direction when the supporting bodies are applied.

22. The method according to claim 21, wherein a transport speed in the transport direction is between 1 m/min and 20 m/min.

23. The method according to claim 21, wherein the supporting bodies are lowered onto the glass sheet from at least one feeding device which is not moved in the transport direction.

24. The method according to claim 23, wherein the feeding device has a plurality of outlet openings in a direction perpendicular to the transport direction for lowering the supporting bodies onto the glass sheet simultaneously.

25. The method according to claim 23, wherein several feeding devices are arranged next to each other in a direction perpendicular to the transport direction.

26. The method according to claim 14, further comprising a second glass sheet, wherein the glass sheet and the second glass sheet are joined together thereby generating a vacuum in a space between the glass sheet and the second glass sheet, and wherein applying the supporting bodies comprises applying the supporting bodies before the glass sheet and the second glass sheet are joined.

27. The method according to claim 14, wherein the glass sheet is a glass sheet for vacuum insulation glass.
